(19) United States
(12) Patent Application Publication
(10) Pub. No.: US 2023/0226565 A1
(43) Pub. Date: Jul. 20, 2023

(54) SPRAYING DEVICE WITH PRE-AIR CONTROL

(71) Applicant: Krautzberger GmbH, Eltville, DE (US)

(72) Inventor: Stefan MOLITOR, Eltville (DE)

(21) Appl. No.: 18/096,730

(22) Filed: Jan. 13, 2023

(30) Foreign Application Priority Data
Jan. 18, 2022 (DE) 102022101089.9

(51) Int. Cl. B05B 7/12; B05B 7/04

(52) U.S. Cl. CPC B05B 7/1272; B05B 7/0416

(57) ABSTRACT

A spraying device with air atomization and pneumatic drive, including at least one air valve for controlling a spraying air flow through the spraying device, at least one media valve for controlling a media flow through the spraying device, at least one first pneumatically actuated drive piston for actuation of the at least one air valve and at least one second pneumatically actuated drive piston for actuation of the at least one media valve.

### FIELD OF THE INVENTION

The present invention relates to a spraying device with air atomization and pneumatic drive.

### BACKGROUND OF THE INVENTION

Spraying devices are used to apply liquid, paste, or powder media to a surface, thereby creating a coating on the surface. The medium to be applied is atomized and directed toward the surface, on which the coating becomes thicker little by little. The media to be applied are, for example, lacquers, paints, waterborne coating systems, adhesives, oils, or release agents, which are delivered by the spraying device under overpressure. When a media valve opens, the medium is discharged along a longitudinal axis and out of a media opening in the nozzle.

In this process, the medium is atomized in different ways based on the design of the spraying device. There are spraying devices that atomize the medium immediately upon discharge via high media pressure in the order of several hundred bar overpressure and the geometry of the media opening, such that a spray jet creates a media mist of particles that are as uniformly and finely distributed as possible. No atomizing air is required therein. This technology will thus be referred to technically as “airless.” Such spraying devices that are operated at media overpressures of up to 300 bar are currently known.

In spraying devices with air atomization, atomizing air and the medium are supplied to the nozzle under high pressure. When the air valve is opened, atomizing air is discharged from the nozzle through air openings and then meets the medium being discharged from the media opening, hereby atomizing it so that here as well, a spray jet creates a media mist of particles that are as uniformly and finely distributed as possible. The media pressure, which is in the order of 1 to 10 bar, is generally significantly lower than that for airless atomization. Such spraying devices that are operated at media overpressures of up to 12 bar are currently known.

In addition to the spraying devices with air atomization, mixed forms of both technologies are subsumed here, in which airless atomization first occurs due to high media pressures and a small media opening, the atomization however additionally being supported by atomizing air, which is also discharged from the nozzle through air openings and then meets the already atomized media mist. Such spraying devices that are operated at media overpressures of up to 150 bar are currently known.

Spraying devices are also known that also have a channel arrangement for delivering shaping air, which is used for adjustment or modification of the geometry of the spray jet. The shaping air is also called “horn air,” as there are usually two horns with outlets in the area of the nozzle, out of which the shaping air is discharged at an angle acute to the longitudinal axis, forming the spray jet. The shaping air is generally separate from the atomizing air and is supplied at different parameters (pressure and volumetric flow rate).

Atomizing air and shaping air are herein combined under the term “spraying air.”

“Spraying device” includes herein all application instances from manual spray guns to fully automated robotic spray equipment. The medium to be applied is applied to the surface by guiding the equipment over the surface to be coated and triggering the spraying process in the designated location, for example in a manual application by an operator holding a spray gun, or in an automatic application by a robot operating fully automated robotic spray equipment.

Spraying devices with air atomization generally also have a pre-air function. Publication DE 808 538 A is referred to as an example, from which a spray gun is known in which a media valve and an air valve are positioned coaxially behind one another, which has advantages in terms of maintenance and care of the spray gun. The valves are thereby connected to one another such that they can be adjusted independently of one another. It is therefore particularly possible to adjust the media valve’s stroke movement cycle relative to that of the air valve such that the air valve opens before the media valve, thereby generating a pre-air. This ensures that the medium being discharged is evenly atomized from its initial discharge on and that no material accumulates at the nozzle, which can cause an uneven spray pattern. For the same reason, in the reverse sequence at the end of the spraying process, the media valve closes first, whereby a post-air prevents material accumulation on the nozzle in the same manner. The spray gun presented in DE 808 538 A is mechanically actuated; that is, the force to open the valves must be applied manually via a trigger.

There are also spraying devices that are actuated by control air in addition to those actuated mechanically. The control air actuates one or more valves for the medium and/or the spraying air, referred to herein as having a “pneumatic drive” (or “having pneumatic drive”). The control air facilitates the work in manual applications because the force to open the valve or valves is provided by the control air, and it enables automatic operation in the first place. A manual spray gun with control air is known, for example, from publication DE 20 004 087 U1. An automatic spray gun with control air is known, for example, from publication EP 3 100 789 A1.

The latter combines a coaxial arrangement of the media valve and the air valve with a pneumatic drive. Here, a drive piston likewise acting on the common axis of the media valve and the air valve moves rearward, that is, away from the nozzle. A first pressure spring generates a preload that presses the piston together with a closing part of the air valve into its valve seat in the idle state. The movement of the drive piston now opens the air valve, whereby a pre-air is first generated as long as the media valve is still closed. Upon continued rearward movement of the drive piston, it engages with an engaging piece attached to a valve stem of the media valve. A preload is exerted on the engaging piece via a second pressure spring that presses the valve stem into its valve seat in the idle state. The drive piston then moves further rearward against the forces of both pressure springs and thereby opens the media valve.

A disadvantage of such an arrangement is that the pressure and the volumetric flow rate of the pre-air and post-air are lower than that of the spraying air because the air valve opens even further upon continued rearward movement of the drive piston together with the media valve. It can be desirable, however, to operate with high pre-air and post-air pressures and volumetric flow rates specifically to avoid material accumulation when starting and terminating the spraying process.

Another disadvantage is that, especially in applications with high media pressures, a high preload of the second pressure spring is required to maintain closure of the media valve in the idle state. The preload cannot be increased limitlessly, however, because it is limited by the force to be applied by the drive piston, which must overcome the spring force of the first pressure spring at the same time.

### SUMMARY OF THE INVENTION

The present invention is therefore based on the task of improving a spraying device of the type mentioned in the beginning such that it, in particular with high media pressures, provides precise control of the pre-air and/or post-air.

The task is solved by a spraying device according to the invention with air atomization and pneumatic drive which comprises at least one media valve for controlling at least one media flow through the spraying device, at least one air valve for controlling at least one spraying air flow through the spraying device, and at least one first pneumatically actuated drive piston for actuation of the at least one air valve, and it is characterized by at least one second pneumatically actuated drive piston for actuation of the at least one media valve.

In contrast to the equipment of the prior art discussed above, the spraying device according to the invention has at least two separate drive pistons for independent actuation of the air valve on one side and the media valve on the other side. This has multiple advantages. Actuation of the air valve on one side and actuation of the media valve on the other side can be triggered without being based on path, whereby the control of the media flow and the control of the spraying air flow can be manifested with greater variability and precision. In particular, the air valve can be fully opened first, before the media valve starts moving, so that the full atomizing air stream is being generated as soon as the medium is first discharged from the nozzle. In particular, the valve switching time can be shortened, as it is no longer a single piston stroke that actuates both valves one after another, but rather two separate strokes are available, which enables a much shorter design with corresponding piston geometry. The shorter switching time effects higher switching dynamics; that is, the duration for turning the spraying device on and off can be shortened, which yields advantages with respect to medium and air consumption, coating speed, and application possibilities. And finally, the work, or force to be applied, to overcome the preload of the media valve and the preload of the air valve is divided between the first and second drive pistons, so that in particular with a high preload for the media valve, the drive pistons and thus the entire housing of the spraying device can have a relatively compact design without a loss of precision.

When herein, as above, the air valve and the media valve are referred to in the singular, this description also refers to a spraying device with multiple media valves for controlling multiple media flows, and/or to a spraying device with multiple air valves for controlling multiple spraying air flows. Multiple media valves come into consideration for, for example, applying a mixture of multiple components. Multiple air valves come into consideration for, for example, independently controlling the atomizing air flows and the shaping air flows. Accordingly, “the first pneumatically actuated drive piston” indicates multiple first pneumatically actuated drive pistons, and “the second pneumatically actuated drive piston” indicates several second pneumatically actuated drive pistons.

The first and second drive pistons are preferably mechanically decoupled.

The drive pistons are considered mechanically decoupled if they are not connected to one another physically (i.e., in form, material, or friction) in such a way that they can only move based on the movement of one other. According to the invention, the movement of the first and second drive pistons is merely imparted by the same control air, and the movements are, however, independent of one another. Even if the first and second drive pistons are arranged or guided through movement in the same single- or multi-part housing of the spraying device, the movement of both pistons is nevertheless independent of one another within the degrees of freedom provided by the piston chambers in the housing.

In a preferred embodiment, the air valve has a corresponding first valve seat and a first closing part that is mechanically coupled to the first drive piston. The closing part can be, for example, a disc, cone, ball, or pin. There can preferably be sealing elements, such as O-rings or similar, between the closing part and the valve seat. The sealing elements can be positively fitted to the closing part or the valve seat. The closing part is particularly preferably designed as a valve plug. “Mechanically coupled” in the sense of this characteristic describes a direct or indirect physical connection in which force is transmitted from the first drive piston to the closing part, optionally mediated by a component between them, such that the movement of the drive piston forces a movement of the closing part.

Particularly preferably, there is a first preload spring that acts on the first drive piston and works against the effective direction thereof, whereby the first drive piston can move linearly forward and rearward between an idle position and an operating position, and whereby the first preload spring presses the first closing part against the first valve seat via the first drive piston.

“Effective direction” refers to the direction of force in which the control air moves the piston. Opposing this effective direction is the preload direction of the first preload spring. A helical compression spring is particularly preferred as the preload spring. The preload spring can be located in a spring housing on the side opposite the piston chamber. “Idle position” refers to the position of the piston in which the spring is minimally compressed and the piston presses the first closing part against the first valve seat via the preload of the first preload spring. No spraying air is discharged from the nozzle in this position. “Operating position” refers to the displaced position of the drive piston, mediated by the control air, in which the first preload spring is maximally compressed and the air valve is fully open. Spraying air is discharged from the nozzle in this position.

Correspondingly, the media valve preferably has a corresponding second valve seat and a second closing part that is mechanically coupled to the second drive piston. The second closing part can also be, for example, a disc, cone, ball, or pin. Here as well, there can preferably be sealing elements, such as O-rings or similar, between the closing part and the valve seat. The sealing elements can likewise be positively fitted to the closing part or the valve seat. The closing part is particularly preferably a valve stem. “Mechanically coupled” in the sense of this characteristic as well describes a direct or indirect physical connection in which force is transmitted from the second drive piston to the second closing part, optionally mediated by a component between them, such that the movement of the second drive piston forces a movement of the second closing part.

Just as for the first and second drive pistons, the first and second closing parts are also preferably mechanically decoupled. This differentiates them from the closing parts of known spraying devices, which are connected to one another in a physical, precise interlocking manner via the single drive piston and the engaging piece with which it is positively engaged. Mechanically decoupling the first and second closing parts and thus the air valve and the media valve yields new possibilities for the construction of the spraying device. For example, there is more spatial freedom for positioning the media valve and the air valve and thus the air and media paths and the corresponding connections in and on the spraying device. This enables simple construction even with complex spraying devices with atomization, control, and horn air functions.

Further preferably, there is a second preload spring that acts on the second drive piston and works against the effective direction thereof, whereby the second drive piston can move linearly forward and rearward between an idle position and an operating position, and whereby the second preload spring presses the second closing part against the second valve seat via the second drive piston between them.

The terminology is analogous to that used previously for “effective direction,” “preload direction,” “idle position,” and “operating position.” A helical compression spring is again particularly preferred as the preload spring. Here also, the preload spring can be located in a spring housing on the side opposite the piston chamber.

In a preferred embodiment, the first drive piston and the second drive piston are arranged along a common longitudinal axis, acting in opposing directions.

The coaxial design generally enables compact design of the spraying device.

Alternatively, the first drive piston and the second drive piston are arranged along different longitudinal axes, acting in different directions.

This construction enables freer design of the drive system (drive pistons and preload springs) and, in particular, relocation of the at least one first pneumatically actuated drive piston, together with the first preload spring if applicable, or of the at least one second pneumatically actuated drive piston, together with the second preload spring if applicable, into a modular housing part or an adapter of the spraying device.

Particularly preferably, a first piston chamber associated with the first drive piston and a second piston chamber associated with the second drive piston are directly fluidly connected to one another and have a common control air supply.

As also in the prior art, the actuation of the media valve and the actuation of the spraying air are hereby controlled by only one control air; however, coupling is pneumatic rather than mechanical. This simplifies the control work compared with separate driving air for the two drive pistons. The timing sequence of opening and closing the air valve and media valve is manifested through the dimensioning of the pistons, in particular the piston surface area and the specifications of the corresponding preload springs, in particular the spring constants, that is, the set preloads. “Piston chamber” refers to the cavity enclosed by the piston surface and the housing surrounding the piston whose volume changes through the movement of the piston. The first and second piston chambers are directly fluidly connected to one another if it is always the case that the control air, or the drive medium, flows between the first and second piston chamber and pressure can automatically equalize between the first piston chamber and the second piston chamber (after a certain time, at any rate).

In a preferred development of the invention, there is a flow restriction in the fluid connection between the first piston chamber and the second piston chamber.

In general, a flow restriction is a reduction in the cross-section of the fluid connection between the first piston chamber and the second piston chamber, which serves to generate a pressure loss to achieve targeted control of the air valve and the media valve. For example, this could achieve a delay between the air valve and the media valve, opening one valve or the other more slowly.

In another advantageous embodiment of the invention, the first piston chamber and the second piston chamber are formed by a common piston chamber.

This essentially constitutes an embodiment in which there is virtually no flow restriction or narrowing between the piston chambers; therefore, the control air flowing into the common piston chamber can be effective on the first piston and the second piston at the same time and pressure. This embodiment also includes spraying devices in which the pistons have different cross-sections, thus naturally forming a change in cross-section between the first and second piston chamber, provided this change in cross-section does not serve the purpose of generating a pressure loss.

Further preferably, the first preload spring and the second preload spring are designed such that the first preload spring in idle position pushes against the first drive piston with a lower preload than that applied by the second preload spring in idle position pushing against the second drive piston. Particularly preferably, the first preload spring has a lower spring constant than the second preload spring.

In this way, considering the dimensioning of the piston surface areas of the first and second drive piston, and given the possible pressure losses in the control air line between the piston chambers, it is ensured that the first drive piston moves first and that the air valve opens before the media valve.

There is preferably a first throttle check valve upstream of the first piston chamber on the inlet side.

In other words, the first throttle check valve is upstream of the first piston chamber in terms of the direction of flow of the control air flowing into the piston chamber. The throttle check valve preferably allows the control air to flow into the first piston chamber unthrottled and throttles the control air upon venting. An asymmetry thus forms between the pressure increase and the pressure decrease in the first piston chamber, wherein the pre-air and post-air can be set, for example, such that the post-air is effective for longer than the pre-air.

If there is a flow restriction in the fluid connection between the first piston chamber and the second piston chamber, this is preferably formed by a second throttle check valve. The second throttle check valve preferably allows the control air to flow out of the first and into the second piston chamber throttled, and unthrottled from the second back into the first piston chamber. The second throttle check valve serves in this case to extend the time for pressure increase in the second piston chamber during control air inflow to extend the pre-air duration.

According to an advantageous development, the spraying device has at least two air valves for controlling a spraying air flow through the spraying device, wherein there are at least two first pneumatically actuated drive pistons for actuation of the at least two air valves.

According to another advantageous development, the spraying device has at least two media valves for controlling a media flow through the spraying device, wherein there are at least two second pneumatically actuated drive pistons for actuation of the at least two media valves.

### BRIEF DESCRIPTION OF THE DRAWINGS

Further characteristics and advantages of the invention are explained in the following with the aid of the example embodiments depicted in the figures. The following are shown:

FIG. 1 shows a first embodiment of the spraying device in the idle position in a lateral sectional view;

FIG. 2 shows the first embodiment of the spraying device in an intermediate position in a lateral sectional view;

FIG. 3 shows the first embodiment of the spraying device in the operating position in a lateral sectional view;

FIG. 4 shows a second embodiment of the spraying device in the idle position in a lateral sectional view;

FIG. 5 shows a third embodiment of the spraying device in the idle position in a lateral sectional view;

FIG. 6 shows the third embodiment of the spraying device in the idle position in a top sectional view;

FIG. 7 shows the third embodiment of the spraying device in an intermediate position in a lateral sectional view;

FIG. 8 shows the third embodiment of the spraying device in the intermediate position in a top sectional view; and

FIG. 9 shows the third embodiment of the spraying device in the operating position in a lateral sectional view.

### DETAILED DESCRIPTION OF THE INVENTION

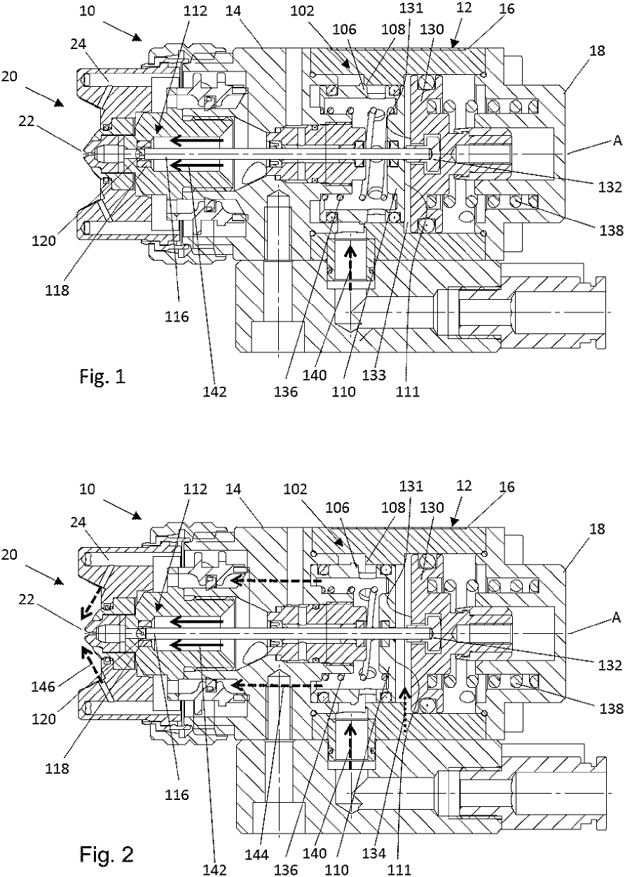

The first example embodiment of the spraying device according to the invention will be explained with the aid of FIGS. 1 through 3. This is a spraying device with air atomization, wherein the medium is primarily atomized via a high media pressure through a small media opening (airless). A secondary air atomization supports the primary airless atomization and improves the spray jet geometry, which is explained next.

FIGS. 1 through 3 are sections in the same plane; therefore, lines for the medium, control air, or spraying air, specifically for the atomizing air or shaping air, are only shown in part or are not shown at all where they are partially or completely located in other planes.

Orientation and direction information, such as “in front of,” “behind,” “rearward,” or “longitudinal” is always relative to the direction of discharge of the medium. For example, the nozzle is thus always “in front” in relation to the housing of the device.

The spraying device 10 comprises a housing 12 that spans along a longitudinal axis A. The housing is a three-part design, and it comprises a front housing part 14, a rear housing part 16, and a housing cover 18 for closure of the rear end of the rear housing part. The three-part design facilitates access to the interior components for simplification of assembly, maintenance, and repair. On the front end of the front housing part 14, there is a nozzle 20, through which the medium to be applied exits and by means of which it is atomized and discharged in the direction of the surface to be coated. The nozzle 20 comprises for this a central media opening 22 for the medium. The geometry of the media opening 22 and in particular the opening cross-section are dimensioned such that in coordination with the media pressure, the medium will be primarily atomized immediately after discharge from the media opening. The nozzle 20 also has feed channels 24 for atomizing air, which meets the media mist immediately after the primary atomization. The atomizing air thus supports the atomization and directs the media mist generated as a spray jet with a desired geometry in the direction of the object to be coated.

The spraying device 10 comprises an air valve 102 in the housing 12 for controlling a spraying air flow. The air valve 102 has a first closing part 106 and a first valve seat 108. The closing part 106 is formed by a conical section whose surface lies against the corresponding first valve seat 108, which is formed by an annular bore step in the housing 12 of the spraying device. A first pneumatically actuated drive piston 110 with a piston surface 111 is mechanically coupled to the closing part 106 for actuation of the air valve. The coupling is manifested in this case by the first closing part 106 being formed as a one-piece component together with the first drive piston 110. The first drive piston 110 is located and guided in a cavity in the housing 12 along the longitudinal axis A such that it is movable forward and rearward.

The spraying device 10 comprises also a media valve 112 in the housing 12 for (binary) controlling a media flow. The media valve 112 has a second closing part 116 and a second valve seat 118. The second closing part 116 is formed by a valve stem, which spans along the longitudinal axis concentrically to and through the direction of movement of the first drive piston 110, and which has at its front end a spherical-cap-shaped sealing surface and a sealing ring 120 that lies against the corresponding second valve seat 118. The geometry of the media opening 22 is responsible for the primary atomization. The media valve 112 is thus moved rearward into the housing interior relative to the media opening 22 and is able to quickly release the maximum cross-section of the media stream due to the spherical-cap shape. The second valve seat 118 is formed as a counterbore at the inlet opening 124 of a borehole 126, through which the medium is guided to the nozzle 20 when the media valve 112 is open. A second pneumatically actuated drive piston 130 with a piston surface 131 is mechanically coupled to the second closing part 116 for actuation of the media valve 112. Coupling occurs via a central bolt 132 via which the valve stem is connected at its rear end to the second drive piston 130 via positive mechanical engagement. The second drive piston 130 is also located and guided in a cavity in the housing 12 along the longitudinal axis A such that it is movable forward and rearward. The first drive piston 110 and the second drive piston 130 are thus arranged along the common longitudinal axis A, acting in opposing directions.

A common piston chamber 133 is formed between the piston surfaces 111, 131 of the two drive pistons 110 and 133. Said piston chamber simultaneously forms the first piston chamber, associated with the first drive piston, and the second piston chamber, associated with the second drive piston. The piston chambers are thereby naturally directly fluidly connected to one another and have a common control air supply, symbolized by arrow 134.

Furthermore, in the housing 12 is a first preload spring 136, which acts on the first drive piston 110 against the effective direction thereof. The preload spring 136 is designed as a helical compression spring, which can be located inside the first drive piston 110 in a space-saving manner. The first drive piston 110 is shown in FIG. 1 in an idle position, in which the first preload spring 136 is pressing the first closing part 106 against the first valve seat 108, mediated by the first drive piston 110. Because the first preload spring 136 is effective rearward and the first drive piston 110 is effective forward, it is possible, in contrast to the prior art, to simultaneously realize a large piston surface area 111 and a large flow cross-section when the air valve 102 is open.

In the same way, in the housing 12 is a second preload spring 138, which acts on the second drive piston 130 against the effective direction thereof. The preload spring 138 is likewise designed as a helical compression spring, which likewise can be located inside the second drive piston 130 in a space-saving manner. The second drive piston 130 is also shown in FIG. 1 in an idle position, in which the second preload spring 138 is pressing the second closing part 116 against the second valve seat 118, mediated by the second drive piston 130. Because the first and second drive pistons 110, 130 are effective in opposite directions, the preload springs 136, 138 are effective in opposite directions. The first preload spring 136 has a lower spring constant than the second preload spring 138. The difference between the preloads is selected such that the first preload spring in the idle position pushes against the first drive piston with a lower preload than that applied by the second preload spring in idle position pushing against the second drive piston. Because the piston surfaces 111, 131 only have a small size differential in the embodiment shown, it is thereby ensured that the first drive piston 110 will move first and that the air valve 102 will open before the media valve 112 opens.

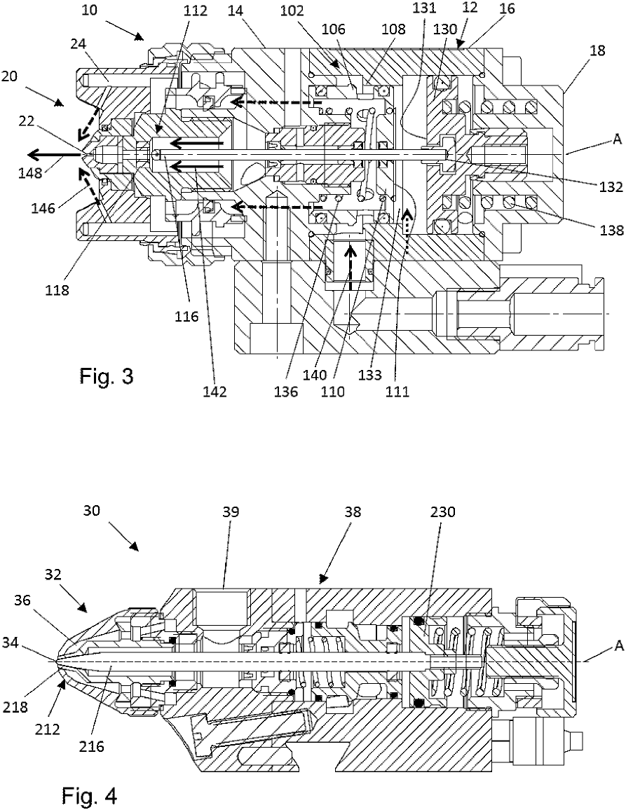

While the valves 102 and 112, as described previously, are closed in FIG. 1, the supply lines upstream of the valves 102 and 112 have spraying air under pressure on one side, symbolized by arrow 140, and the medium under pressure on the other side, symbolized by arrows 142. Startup of the spraying device 10 occurs via the pressurization of the common piston chamber 133 with control air 134, wherein the first occurrence is that the first drive piston 110 is driven against the first preload spring 136, thus opening the coupled air valve 102, as depicted in FIG. 2. In the intermediate position shown here, the first drive piston 110 is already displaced to its maximum stroke in the forward direction, and therefore the air valve 102 is already fully open, while the higher preload of the second preload spring 138 keeps the media valve 112 fully closed. In the intermediate position, the spraying air, symbolized by arrow 144, flows through the spraying device 10, referred to at this point in time as pre-air, symbolized by arrow 146, and exits the nozzle 20 without medium. If the pressure of the control air 134 further increases in the piston chamber 133, the second drive piston 130 will be driven against the second preload spring 138 and the coupled media valve 112 will open, as depicted in FIG. 3. In the operating position shown here, both drive pistons 110 and 130 are displaced to their maximum stroke to the front or rear, respectively, such that the air valve 102 and the media valve 112 are completely open. In the operating position, the spraying air, symbolized by arrow 144, and the medium, symbolized by arrow 142, flow through the spraying device 10 and simultaneously exit the nozzle 20, symbolized by the arrows 146 and 148, wherein the medium is atomized and is directed toward the object to be coated. When terminating the spraying process, the media valve 112 and the air valve 102 are closed in the opposite order so that a post-air is discharged from the nozzle in the intermediate position, which blows the nozzle clean of media residue.

The second example embodiment of the spraying device according to the invention will be explained with the aid of FIG. 4. Here as well, the lines for the medium or the spraying air, or specifically for the atomizing air, control air, and shaping air, are only shown in part or are not shown at all where they are partially or completely located in other planes.

The spraying device 30 according to the second example embodiment has, analogous to the first example, first and second drive pistons along a common longitudinal axis, acting in opposing effective directions, each with associated valves and preload springs. It is different from the first example embodiment primarily in terms of the dimensioning of the components as well as a differing nozzle geometry. Therefore, the following description will essentially only consider the differences, while the preceding description of the first example embodiment is otherwise referred to.

The spraying device 30 according to FIG. 4 is an embodiment that only works with the assistance of air atomization; that is, unlike the example embodiment according to FIGS. 1 through 3, it does not atomize primarily “airlessly.” The spraying device 30 comprises in particular a nozzle 32 at the front end, which differs from the nozzle 20 in that the atomizing air exits through an annular mouth of an annular feed channel 36, wherein the mouth is concentrically around the media opening 34 for the medium. The channel structure inside the housing 38 has corresponding design differences.

The nozzle 32 is also different from the nozzle 20 in terms of the media supply. The medium is supplied through a media connection 39 under a relatively low overpressure (12 bar maximum), wherein a different media valve 212 and different cross-sections for the lines inside the housing 38 are necessary. This media valve 212 is also designed as a needle valve. It has a second closing part 216 in the form of a valve stem and a second corresponding valve seat 218. However, the tip of the valve stem is a conical tapered point in this case, and it enters a conical borehole of the same conical dimensioning in a form-fitting manner without an additional sealing element when the media valve 212 is closed. The sealing surface of the valve seat 218 also transitions directly to the central media opening 34, through which the medium discharges without atomization. With this construction, it is possible to set the media flow as required via an adjustable end position of the valve stem relative to the valve seat 218. The second pneumatically actuated drive piston 230 is likewise mechanically coupled to the second closing part 216, for example by a threaded connection, for actuation of the media valve 212.

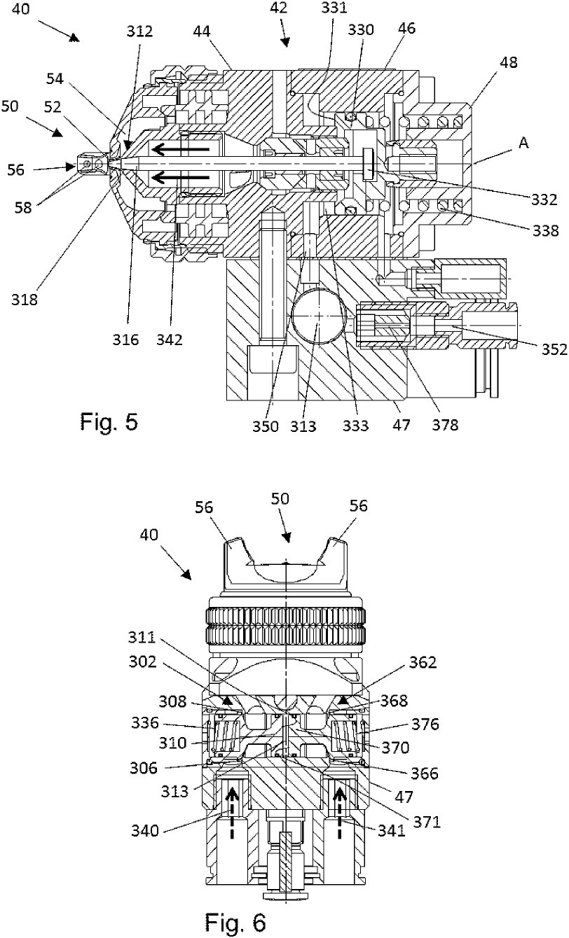

The third example embodiment of the spraying device according to the invention will be explained with the aid of FIGS. 5 through 9. These show sections in two planes that are perpendicular to each other. Here as well, the lines for the medium or the spraying air, or individually for the atomizing air, control air, and shaping air, are only shown in part or are not shown at all where they are partially or completely located in other planes.

The spraying device 40 comprises a housing 42 that spans along a longitudinal axis A. The housing is a four-part construction and comprises a front housing part 44, a rear housing part 46, an adapter 47 connected lateral to the front and rear housing parts 44, 46 relative to the longitudinal axis A, and a housing cover 48 for closing off the rear end of the rear housing part 46. On the front end of the front housing part 44, there is a nozzle 50, through which the medium to be applied exits and by means of which it is atomized and discharged in the direction of the surface to be coated. The nozzle 50 comprises for this a central media opening 52 for the medium. The nozzle 50 also has an annular mouth of an annular feed channel 54, the annular mouth being concentrically around the media opening 52, and being the component out of which the atomizing air escapes, and which atomizes the escaping medium and directs the media mist generated thereby as a spray jet in the direction of the object to be coated. There are also shaping air channels, not shown, that are separate from the feed channel 54 and that open into two horns 56, which are mirrored opposite one another relative to the longitudinal axis A. The shaping air exits the horn mouths 58 at an acute angle to the longitudinal axis and then meets and shapes the spray jet. This spraying device 40 is used in a robotic system with air atomization and separate shaping air for automatic applications.

The spraying device 40 comprises an air valve 302 in the adapter 47 of the housing 42 for controlling a spraying air flow 340. The air valve 302 has a first closing part 306 and a first valve seat 308. The closing part 306 is formed by a conical section whose surface lies against the corresponding first valve seat 308, which is formed by an annular bore step in the adapter 47 of the spraying device. A first pneumatically actuated drive piston 310 with a first piston surface 311 is mechanically coupled to the closing part 306 for actuation of the air valve. The coupling is manifested in this case by the first closing part 306 being formed as a one-piece component together with the first drive piston 310. The first drive piston 310 is located and guided in a cavity in the adapter 47 perpendicular to the longitudinal axis A such that it can move back and forth. A first piston chamber 313 is associated with the first drive piston 310 and forms a variable part of the cavity delimited by the first piston surface 311.

The spraying device 40 comprises also a media valve 312 in the housing 42 for controlling a media flow 342. This media valve 312 is also designed as a needle valve than spans along the longitudinal axis A. It has a second corresponding valve seat 318 and a second closing part 316 in the form of a valve stem. Like in the second example, the tip of the valve stem is a conical tapered point, and it mates with the second valve seat 318, which is a conically tipped borehole of the same conical dimensioning, in a form-fitting manner without an additional sealing element when the media valve 312 is closed. The sealing surface of the valve seat 318 again transitions directly to the central media opening 52. A second pneumatically actuated drive piston 330 with a second piston surface 331 is mechanically coupled to the second closing part 316 for actuation of the media valve 312. Coupling occurs via a central bolt 332, via which the valve stem is connected at its rear end to the second drive piston 330 via positive mechanical engagement. The second drive piston 330 is located and guided in a cavity in the rear housing part 46 of the housing 42 along the longitudinal axis A such that it is movable forward and rearward. A second piston chamber 333 is associated with the second drive piston 330 and forms a variable part of the cavity delimited by the piston surface 331.

In contrast to the first example, the first drive piston 310 and the second drive piston 330 are not coaxially arranged. Nevertheless, the first piston chamber 313, associated with the first drive piston 310, and the second piston chamber 333, associated with the second drive piston 330, are directly fluidly connected to one another and to a common control air supply 352 via a connecting line 350, referred to here also as a fluid connection. In the fluid connection 350 between the first piston chamber 313 and the second piston chamber 333 is a flow restriction in the form of the connecting line 350 itself. Because this constitutes a cross-sectional reduction with respect to the cross-sections of the piston chambers 313 and 333, it effects a pressure drop along its length, such that pressure builds up more slowly in the second piston chamber 333 than in the first piston chamber 313. There can also be a second throttle check valve in this location instead of a cross-sectional reduction.

Furthermore, in the adapter 47 of the housing 42 is a first preload spring 336, which acts on the first drive piston 310 against the effective direction thereof. The preload spring 336 is designed as a helical compression spring, which can be located inside the first drive piston 310 in a space-saving manner. The first drive piston 310 is shown in FIG. 6 in an idle position, in which the first preload spring 336 is pressing the first closing part 306 against the first valve seat 308, mediated by the first drive piston 310. Here as well, the first preload spring 336 and the first drive piston 310 are in opposition, whereby a large piston surface area 311 and a large flow cross-section are simultaneously possible with an open air valve 302.

In the same way, in the housing part 46 of the housing 42 is a second preload spring 338, which acts on the second drive piston 330 against the effective direction thereof. The preload spring 338 is likewise designed as a helical compression spring, which can be located inside the second drive piston 330 in a space-saving manner. The second drive piston 330 is also shown in FIG. 5 in an idle position, in which the second preload spring 338 is pressing the second closing part 316 against the second valve seat 318, mediated by the second drive piston 330.

The first preload spring 336 has a lower spring constant than the second preload spring 338. The first preload spring 336 and the second preload spring 338 are designed such that the first preload spring 336 in the idle position presses against the first drive piston 310 with a lower preload than that of the second preload spring 338 in the idle position pressing against the second drive piston 330, and to such a degree that considering the size difference between the first and second piston surface areas 311, 331, and considering where applicable a pressure loss across the connecting line 350, the first drive piston 310 is moved first, and the air valve 302 opens before the media valve 312.

In contrast to all previous examples, there is also a second air valve 362 in the adapter 47 of the housing 42 for separate control of a shaping air flow. The second air valve 362 has a mirror-image construction to the air valve 302 in the view of FIG. 6. The second air valve 362 accordingly has another first closing part 366 and another first valve seat 368. The closing part 366 is formed by a conical section whose surface lies against the corresponding valve seat 368, which is formed by an annular bore step in the adapter 47 of the spraying device 40. Accordingly, another first pneumatically actuated drive piston 370 with a piston surface 371 is mechanically coupled to the closing part 366 for actuation of the second air valve 362. Coupling is manifested, as in the case of the first drive piston 310 with the air valve 302, by the first closing part 366 being formed as a one-piece component together with the first drive piston 370. The first drive piston 370 is also located and guided perpendicular to the longitudinal axis A in a cavity in the adapter 47 such that it is movable back and forth in the opposite direction as the first drive piston 310. The same first piston chamber 313 as the first drive piston 310 is associated with the first drive piston 370.

Also analogous is another first preload spring 376, which acts on the first drive piston 370 against the effective direction thereof. The preload spring 376 is designed as a helical compression spring, which can be located inside the first drive piston 370 in a space-saving manner. The first drive piston 370 is shown in FIG. 6, like the first drive piston 310, in an idle position, in which the preload spring 376 presses the closing part 366 against the valve seat 368, mediated by the first drive piston 370. Here as well, the preload spring 376 and the first drive piston 370 are in opposition, whereby a large piston surface 371 and a large flow cross-section are simultaneously possible with an open second air valve 362. The preload spring 376, with a piston surface 371 of the same size and a common first piston chamber 313, is designed, like preload spring 336, such that the first drive piston 370 is moved at the same time as the first drive piston 310 and before the second drive piston 330, so that the second air valve 362 opens at the same time as the air valve 302 before the media valve 312.

At the inlet side, that is, between the first piston chamber 313 and the control air supply 352, there is also a first throttle check valve 378 upstream of the first piston chamber 313 in the adapter 47. The first throttle check valve 378 allows the control air to flow into the first piston chamber 313 unthrottled, but it then throttles the control air upon venting, such that a dynamic pressure forms in the first piston chamber upon venting. An asymmetry thus develops between the pressure increase and the pressure decrease.

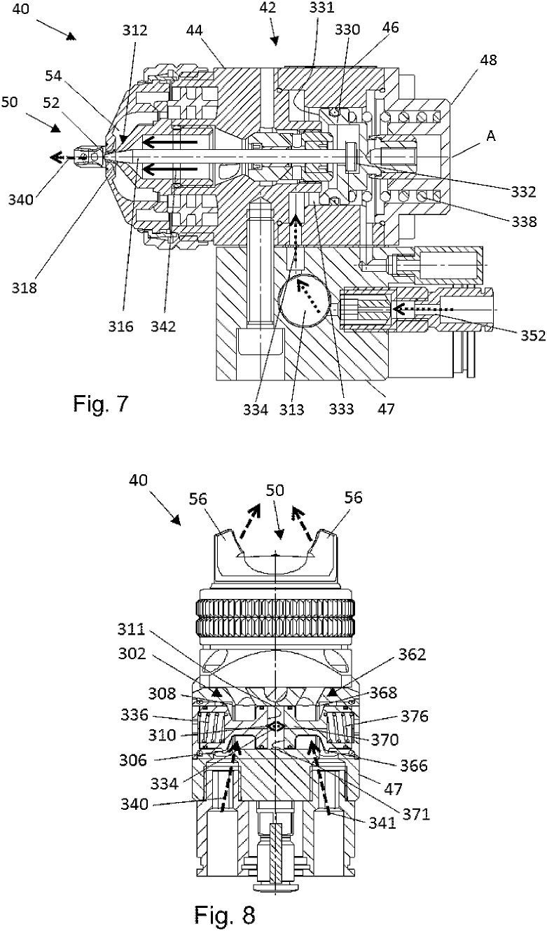

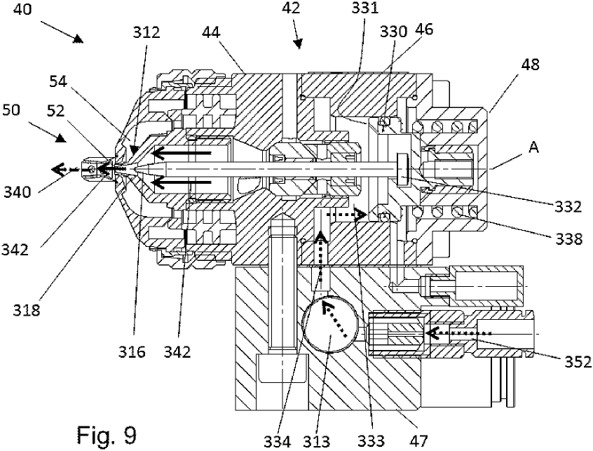

While the valves 302, 312, and 362, as described previously, are closed in FIGS. 5 and 6, the supply lines have atomizing air, symbolized by arrow 340, or shaping air, symbolized by arrow 341, upstream of the valves 302 and 362, and the medium on the other side, symbolized by arrow 342, all of which are pressurized. Startup of the spraying device 40 occurs via the pressurization of the piston chambers 313 and 333 with control air 334, wherein the first occurrence is that the first drive pistons 310, 370 are driven against the respective first preload springs 336, 376, thus opening the air valves 302, 362, as illustrated in FIGS. 7 and 8. In the intermediate position shown here, the first drive pistons 310, 370 are each already displaced to their maximum stroke so that the air valves 302, 362 are completely open while the higher preload of the second preload spring 338 still maintains the media valve 312 closed upon a simultaneous potential pressure decrease in the connecting line 350. In the intermediate position, the atomizing air, symbolized by arrow 340, and the shaping air, symbolized by arrow 341, flows through the spraying device 40 and at this point in time exits the nozzle as pre-air without medium. If the pressure of the control air 334 further increases in the piston chamber 333, the second drive piston 330 will be driven against the second preload spring 338 and the coupled media valve 312 will open, as depicted in FIG. 9. In the operating position shown here, all three drive pistons 310, 330, and 370 are displaced to their maximum stroke to the side or rear, respectively, so that the air valves 302, 362 and the media valve 312 are completely open. In the operating position, the atomizing air, symbolized by arrow 340, the shaping air (not shown in FIG. 9), and the medium, symbolized by arrow 342, flow through the spraying device 40 and simultaneously exit the nozzle 50, wherein the medium is atomized and is directed toward the object to be coated in the set shape of the spray jet. When terminating the spraying process, the media valve 312 and the air valves 302, 362 are closed in the opposite order so that in the intermediate position, a post-air, comprising atomizing air and shaping air, is discharged from the nozzle, which blows the nozzle clean of media residue. The aforementioned asymmetry between the pressure increase and the pressure decrease in the first piston chamber 313 extends the post-air duration.

As is seen in the preceding example, the invention provides for a powerful spraying device whose drive exhibits both efficiency and low susceptibility to wear due to lower stress on the individual components. The spraying device also requires fewer components than the prior art. It is therefore advantageous in terms of both service life and maintenance.

Reference designations

| | |
|---|---|
| 10 | Spraying device |
| 12 | Housing |
| 14 | Front housing part |
| 16 | Rear housing part |
| 18 | Housing cover |
| 20 | Nozzle |
| 22 | Media opening |
| 24 | Feed channel |
| 30 | Spraying device |
| 32 | Nozzle |
| 34 | Media opening |
| 36 | Feed channel |
| 38 | Housing |
| 39 | Media connection |
| 40 | Spraying device |
| 42 | Housing |
| 44 | Front housing part |
| 46 | Rear housing part |
| 47 | Adapter |
| 48 | Housing cover |
| 50 | Nozzle |
| 52 | Media opening |
| 54 | Feed channel |
| 56 | Horn |
| 58 | Horn mouth |
| 102 | Air valve |
| 106 | First closing part |
| 108 | First valve seat |
| 110 | First drive piston |
| 111 | Piston surface |
| 112 | Media valve |
| 116 | Second closing part |
| 118 | Second valve seat |
| 120 | Sealing ring |
| 124 | Inlet mouth |
| 126 | Borehole |
| 130 | Second drive piston |
| 131 | Piston surface |
| 132 | Bolt |
| 133 | Piston chamber |
| 134 | Arrow: Control air |
| 136 | First preload spring |
| 138 | Second preload spring |
| 140 | Arrow: Spraying air |
| 142 | Arrow: Medium |
| 144 | Arrow: Spraying air |
| 146 | Arrow: Spraying air |
| 148 | Arrow: Medium |
| 212 | Media valve |
| 216 | Second closing part |
| 218 | Second valve seat |
| 230 | Second drive piston |
| 302 | Air valve |
| 306 | First closing part |
| 308 | First valve seat |
| 310 | First drive piston |
| 311 | First piston surface |
| 312 | Media valve |
| 313 | First piston chamber |
| 316 | Second closing part |
| 318 | Second valve seat |
| 330 | Second drive piston |
| 331 | Second piston surface |
| 332 | Bolt |
| 333 | Second piston chamber |
| 334 | Control air |
| 336 | First preload spring |
| 338 | Second preload spring |
| 340 | Spraying air flow |
| 342 | Media flow |
| 350 | Connecting line |
| 352 | Control air supply |
| 362 | Second air valve |
| 366 | Additional first closing part |
| 368 | Additional first valve seat |
| 370 | Additional first drive piston |
| 371 | Piston surface |
| 376 | Additional first preload spring |
| 378 | Throttle check valve |

What is claimed:

1. A spraying device with air atomization and pneumatic drive, comprising:
at least one air valve for controlling a spraying air flow through the spraying device,
at least one media valve for controlling a media flow through the spraying device, and
at least one first pneumatically actuated drive piston for actuation of the at least one air valve, and
at least one second pneumatically actuated drive piston for actuation of the at least one media valve.

2. The spraying device according to claim 1, wherein the at least one first drive piston and the at least one second drive piston are mechanically decoupled.

3. The spraying device according to claim 1, wherein the at least one air valve comprises a first valve seat and a first closing part, which is preferably a valve plug, that is mechanically coupled to the at least one first drive piston.

4. The spraying device according to claim 3, wherein a first preload spring that acts on the at least one first drive piston and works against the effective direction thereof, whereby the at least one first drive piston can move linearly back and forth between an idle position and an operating position, and whereby the first preload spring presses the first closing part against the first valve seat, mediated by the at least one first drive piston.

5. The spraying device according to claim 1, wherein the media valve comprises a second valve seat and a second closing part, which is preferably a valve stem, that is mechanically coupled to the at least one second drive piston.

6. The spraying device according to claim 5, wherein a second preload spring that acts on the at least one second drive piston and works against the effective direction thereof, whereby the at least one second drive piston can move linearly back and forth between an idle position and an operating position, and whereby the second preload spring presses the second closing part against the second valve seat, mediated by the at least one second drive piston.

7. The spraying device according to claim 1, wherein the at least one first drive piston and the at least one second drive piston are arranged along a common longitudinal axis, acting in opposing effective directions.

8. The spraying device according to claim 1, wherein the at least one first drive piston and the at least one second drive piston are arranged along different longitudinal axes, acting in different effective directions.

9. The spraying device according to claim 1, wherein a first piston chamber associated with the at least one first drive piston and a second piston chamber associated with the at least one second drive piston and are directly fluidly connected to one another and have a common control air supply.

10. The spraying device according to claim 9, wherein there is a flow restriction in the fluid connection between the first piston chamber and the second piston chamber.

11. The spraying device according to claim 10, wherein the flow restriction is formed by a second throttle check valve.

12. The spraying device according to claim 7, wherein a first piston chamber associated with the at least one first drive piston and a second piston chamber associated with the at least one second drive piston are formed by a common piston chamber having a common control air supply.

13. The spraying device according to claim 6, wherein a first preload spring that acts on the at least one first drive piston and works against the effective direction thereof, whereby the at least one first drive piston can move linearly back and forth between an idle position and an operating position, and whereby the first preload spring presses the first closing part against the first valve seat, mediated by the at least one first drive piston and wherein the first preload spring and the second preload spring are designed such that the first preload spring in the idle position pushes against the at least one first drive piston with a lower preload than that applied by the second preload spring in the idle position pushing against the at least one second drive piston.

14. The spraying device according to claim 13, wherein the first preload spring has a lower spring constant than the second preload spring.

15. The spraying device according to claim 9, wherein there is a first throttle check valve upstream of the first piston chamber on the inlet side.

16. The spraying device according to claim 1, wherein there are at least two air valves for controlling a spraying air flow through the spraying device, wherein there are at least two first pneumatically actuated drive pistons for actuation of the at least two air valves.

17. The spraying device according to claim 1, wherein there are at least two media valves for controlling a media flow through the spraying device, wherein there are at least two second pneumatically actuated drive pistons for actuation of the at least two media valves.
